(19) United States
(12) Patent Application Publication
(10) Pub. No.: US 2026/0077426 A1
(43) Pub. Date: Mar. 19, 2026

(54) SENSOR DEVICE FOR MONITORING A LASER MACHINING PROCESS AND A LASER MACHINING SYSTEM COMPRISING THE SAME

(71) Applicant: Precitec GmbH & Co. KG, Gaggenau (DE)

(72) Inventors: Rainer KRAFT, Ettlingen (DE); Matthias STREBEL, Gaggenau (DE)

(73) Assignee: Precitec GmbH & Co. KG, Gaggenau (DE)

(21) Appl. No.: 19/327,504

(22) Filed: Sep. 12, 2025

(30) Foreign Application Priority Data
Sep. 13, 2024 (DE) 10 2024 126 449.7

(51) Int. Cl. B23K 26/03

(52) U.S. Cl. CPC B23K 26/032

(57) ABSTRACT

A sensor device for monitoring a laser machining process is provided. The sensor device includes at least one filter module for filtering a process beam generated during the execution of the laser machining process, and a sensor unit for detecting an intensity of the filtered process beam in at least two measurement channels by at least two photosensors. The filter module is configured to adjust at least one partial wavelength range of the process beam that is detectable in one of the measurement channels of the sensor unit. A laser machining system with the sensor device is also provided.

### CROSS-REFERENCE TO RELATED APPLICATION

This application claims priority to German Patent Application No. 102024 126 449.7 filed on September 13, 2024. The disclosure of the above-identified application, including the specification, drawings, and claims, is incorporated by reference herein in its entirety.

### TECHNICAL FIELD

The present disclose relates to a sensor device for monitoring a laser machining process, in particular, a sensor device for monitoring a laser machining process (in particular a laser welding process) with optical filtering of the optical process emissions, and a laser machining system with the sensor device.

### BACKGROUND

In a laser machining system, also referred to as a laser machining plant, the laser beam emitted by a laser beam source or the end of a laser guide fiber is directed onto a workpiece to be machined by beam guiding and focusing optics. Machining may comprise laser welding or laser cutting. The laser machining system may comprise a laser machining head, for example a laser welding head or a laser cutting head, in which the optics are arranged. For example, the laser machining process may comprise a laser welding process and a laser cutting process.

In order to ensure the quality of the machining, it is important to continuously monitor the laser machining process. Monitoring is typically performed by sensing and evaluating optical process emissions generated during the laser machining process, i.e. light returned from the process. The optical process emissions include the laser radiation scattered or reflected back by the workpiece (called laser back reflection), radiation generated in the (near) infrared wavelength range of light (called infrared wavelength range), e.g. including temperature radiation from a melt pool, and radiation generated in the visible wavelength range of light, e.g. including radiation from a plasma generated during machining. The optical process emissions may be referred to as process radiation or process beam.

The process beam is typically detected by photodiodes. The photodiodes may be part of a sensor unit arranged on the laser machining head. The process beam may be coupled into the sensor unit via the laser machining head. In the sensor unit, the process beam is split into partial beams, each with a different wavelength range, by a beam splitter arrangement with one or more beam splitters with a wavelength-selective coating or by optical filters behind the beam splitter arrangement. The photodiodes each detect the intensity of a corresponding partial beam with the specified wavelength range and generate a corresponding sensor signal. The sensor signal corresponds to the average intensity of the respective wavelength range. Changes in the measured intensity with respect to reference data are an indicator of errors that have occurred in the laser machining process performed. For monitoring purposes, the sensor signal curves are compared, for example, with predetermined envelopes and/or threshold values, and an error is output if a sensor signal is outside the envelopes or exceeds or falls below a threshold value. Error detection can be further optimized by evaluating the intensity of different wavelength ranges.

In order to ensure versatile applications of the sensor unit for process monitoring, it is usually configured with relatively broad-band measurement channels. Typical sensor units each have a measurement channel for the visible wavelength range, the infrared wavelength range, and for the laser beam wavelength (also known as the "back-reflection wavelength range"), which generally allow for good process monitoring and, due to their broadband configuration, are not limited to predefined applications. Due to the broadband measurement channels (e.g., with a width of approx. 500 nm or more), only the total intensity of the corresponding partial beam can be detected in a large, i.e., broadband, wavelength range (so-called integral sensor signal or integral intensity detection) and be used for process monitoring.

In certain cases, however, a more precise definition of the measurement channels or a higher spectral resolution is advantageous for error detection or process monitoring, but subsequent adjustment of a typical sensor unit, which is often provided as a self-contained functional unit, is not easily possible. In this case, the sensor unit would have to be replaced.

For example, the sensor unit captures the sensor signal for the visible wavelength range from 350 nm to 850 nm, the sensor signal for the laser back-reflection in the wavelength range from 1000 nm to 1100 nm, and the sensor signal for the infrared wavelength range in the wavelength range greater than 1200 nm. Changes in intensity of different wavelengths included in the respective measurement channel cannot be distinguished, thereby reducing error sensitivity due to a lower relative change signal. In the worst case, certain errors, for which the intensity changes of different wavelengths in the measurement channel cancel each other out, cannot be recognized at all.

In addition, the different wavelength ranges of the partial beams partially overlap since the beam splitters do not allow complete separation of the wavelength ranges. When detecting the intensity of the respective partial beams, facilitated by the broadband spectral sensitivity of the photosensors, crosstalk occurs, i.e., the photosensors also detect the intensity of unwanted wavelength ranges. In order to remove the unwanted wavelength ranges in a partial beam, additional filters after the beam splitter have to be provided.

On the other hand, for other economic and/or technical reasons, it is often desirable to provide a sensor unit with measurement channels that have the broadest possible spectral sensitivity in the three wavelength ranges mentioned above in order to allow for a sensor unit for process monitoring to be used as universally as possible.

### SUMMARY

The inventors have recognized that such integral intensity detection or intensity detection in a broadband wavelength range can be disadvantageous for precise monitoring of laser machining processes, in particular laser welding processes.

Since the sensor signal corresponds to the average intensity of the process beam in the detected wavelength range, for certain process errors no changes are detectable in the sensor signal, even though there is a change in intensity at individual wavelengths in the wavelength range.

This is explained in FIG. 9. FIG. 9 shows a diagram illustrating the intensity of the process beam during laser welding in a broadband wavelength range (λ1 to λ3), e.g., the visible wavelength range. The solid line shows the intensity of the process beam as a function of wavelength λ at a time when a process error occurs, while the dashed line shows the intensity for laser welding without the process error. On the left side of the diagram (partial wavelength range λ1 to λ2), the process error results in a decrease in intensity compared to the case without a process error, while on the right side (partial wavelength range λ2 to λ3), there is an increase in intensity compared to the case without a process error. However, if only one sensor signal is detected for the intensity in the large or broadband wavelength range between λ1 and λ3, a change within the individual partial wavelength ranges λ1 to λ2 and λ2 to λ3 cannot be detected because the intensity changes in the two partial wavelength ranges cancel each other out. Consequently, the process error and a faulty welded workpiece resulting from the process error cannot be detected either.

It is therefore an object of the present disclosure to provide a sensor device that allows for improved, in particular more precise, monitoring of a laser machining process and that allows for improved detection of process errors.

It is an object of the present disclosure to provide a sensor device that allows for monitoring of a laser machining process based on intensities of a process beam detected independently and separately from each other for a plurality of different wavelength ranges.

It is an object of the present disclosure to provide a sensor device with a high spectral resolution with respect to material-specific emission ranges, in particular in the visible wavelength range.

It is an object of the present disclosure to provide a sensor device, the spectral sensitivity of which can be adapted for process monitoring of different laser machining processes.

It is an object of the present disclosure to provide a sensor device that can be used flexibly for process monitoring.

In particular, it is an object of the present disclosure to provide a sensor device that makes it possible to individually adapt a partial wavelength range of the process beam, which can be detected in a measurement channel, for monitoring the laser machining process, in particular to make it narrowband.

It is an object of the present disclosure to provide a sensor device that allows for an amplification of a sensor signal for different wavelength ranges of the process beam to be individually configured and/or adjusted.

It is also an object of the disclosure to provide a laser machining system with such a sensor device.

At least one of these objects, embodiments, and further developments are achieved by the subject matter of the claims.

The present disclosure is based on the finding that monitoring a laser machining process is disadvantageous if the intensity of the process beam is only detected in large, broadband measurement channels. That is, certain effects or errors in the laser machining process cannot be recognized because the intensity respectively detected only indicates the average intensity in the broadband measurement channel. In addition, the detection merely of broadband measurement channels makes it difficult or impossible to precisely configure and adjust the monitoring. A measurement channel can be defined as a spectral wavelength range for which the sensor unit is configured to detect a corresponding sensor signal. The sensor unit may have a plurality of measurement channels and detect a plurality of sensor signals accordingly. The sensor signal can then be evaluated and/or recorded. For example, the sensor unit may have one measurement channel each in the visible wavelength range, in the infrared wavelength range, and in the back-reflection wavelength range. The width of a measurement channel is determined by the spectral sensitivity of the corresponding photodiodes themselves and by optical elements of the sensor device, such as filters or beam splitters, in the beam path of the process beam or a partial beam thereof in front of the corresponding photodiode. A measurement channel is therefore not exclusively the spectral sensitivity range of a photosensor.

The present disclosure is based on the idea of filtering the process beam in a sensor device with a sensor unit by a filter module in such a way that, in the (continuous) spectrum of the process beam, at least one partial wavelength range of the process beam, which can be detected in one of the measurement channels of a sensor unit of the sensor device, is adjusted. Using the filter module, a partial wavelength range in the spectrum of the process beam that can be detected by a measurement channel, is thus adjusted. in particular by limiting and/or narrowing it on one or both sides. The adjusted partial wavelength range is narrower than the unadjusted partial wavelength range. In other words, the adjusted partial wavelength range that can be detected in the one measurement channel is narrower than the measurement channel (or the wavelength range of this measurement channel) itself.

Subsequently, the intensity of the process beam filtered by the filter module can be detected individually or separately in the respective measurement channels by the photosensors of the sensor unit.

Compared to conventional solutions, the present disclosure offers the possibility of expanding an existing sensor unit with a filter module. The "pre-filtering" in the filter module in combination with the downstream elements of the sensor unit, e.g., optical filters, beam splitters, etc., allows for customized adjustment of the sensor device with regard to one or more measurement channels for a specific application. Unlike optical filters in a partial beam after a beam splitter in the sensor unit, the filter module is connected upstream of these elements of the sensor unit.

It is not necessary to the present disclosure whether the filter insert is provided in the sensor unit itself or whether the filter module is a component separate from the sensor unit which is arranged in the beam path of the process beam in front of the sensor unit. In the latter case, existing sensor units without an existing filter module insert can be retrofitted. In this case, the filter module may have a separate enclosed housing with optical input and output and be arranged in front of the sensor unit. This allows for a modular design of the sensor unit or sensor device.

The filter module is thus to be understood as a supplement to a sensor unit with predefined measurement channels for process-specific optimization of the existing (broadband) measurement channels. The resulting adapted partial wavelength range(s) of the process beam, which can be detected in the respective measurement channels, are narrower compared to the sensor unit without a filter module. This increases the spectral resolution of the sensor unit with respect to the respective individual measurement channels. The spectral resolution of the sensor device according to the present disclosure can then be determined both by the sensor unit and by the optical filtering in the filter module. For example, for an existing sensor unit, a single long-pass filter in the filter module may be a possible filter configuration to limit the visible wavelength range of the measurement channel for the visible wavelength range (by a new lower measurement range limit) without changing the other measurement channels.

With the filter module, existing sensor units with broadband measurement channels can be retrofitted or supplemented for the accurate detection of intensity in a narrowband wavelength range. In addition, this allows the sensor unit or sensor device to be configured in a modular fashion. That is, a different filter module can be used for different specified laser machining processes, each of which requires monitoring in a different narrowband wavelength range. In this case, the filter module may be configured as a filter cartridge or as a filter insert for a filter cartridge. The filter module may therefore be a coaxial filter cartridge module with a filter insert containing at least one filter. This makes it possible to configure the sensor unit in a simple, modular, and cost-effective manner that is specific to processes.

The individual detection of the intensity in the adjusted narrower partial wavelength range of the process beam allows for more precise monitoring of the laser machining process because the intensity in said wavelength range is detected without overlap and thus certain process errors can be detected for the first time at all or more effectively. In particular, the intensity of the process beam can be detected and monitored at one or more specified material-specific emission wavelengths.

Detecting and/or processing and/or evaluating the adjusted partial wavelength range can be performed separately from the other partial wavelength ranges of the process beam and thus individually. The corresponding sensor signals can be amplified separately and/or differently from each other. This allows for each generated sensor signal to be subjected to individual amplification. The present disclosure allows, for example, individual amplification of the sensor signals of the wavelength ranges in a wide range of orders of magnitude, for example by a factor of 10 to 10⁷ or 10⁸.

The term "visible wavelength range" refers to a wavelength range that predominantly comprises wavelengths in the visible spectrum of light. In particular, the visible wavelength range may be a wavelength range between 350 nm and 850 nm or between 390 nm and 850 nm or between 380 nm and 800 nm, or comprise such a wavelength range.

The term "infrared wavelength range" refers to a wavelength range that comprises wavelengths in the infrared spectral range. In particular, the infrared wavelength range may be a wavelength range greater than 1200 nm, in particular between 1200 nm and 2100 nm, or comprise such a wavelength range.

The term "back-reflection wavelength range" refers to a wavelength range that comprises the wavelength of the laser beam, which is, for example, between 1000 nm and 1100 nm.

Furthermore, "visible partial beam" refers to a partial beam in the visible wavelength range, "infrared partial beam" refers to a partial beam in the infrared wavelength range, and "back-reflection partial beam" refers to a partial beam in the back-reflection wavelength range. "Non-overlapping" wavelength ranges means that no wavelength from one wavelength range is contained in the other wavelength range. "Non-overlapping" is synonymous with "completely different from each other."

A partial wavelength range of the process beam is detectable and/or is detected in one of the measurement channels of the sensor unit may be referred to as the measurement channel wavelength range (of the process beam). When, for example, the sensor unit has three measurement channels, the spectrum of the process beam may comprise, for example, three measurement channel wavelength ranges. In the context of this disclosure, detecting a wavelength range or a (partial) beam means that the intensity in this wavelength range or the intensity of the (partial) beam is detected.

When elements are numbered, for example, "first element," "second element," "third element," etc., this numbering is not intended to indicate a necessary order, but is merely used to distinguish the elements.

According to one aspect of the present disclosure, a sensor device for monitoring a laser machining process for machining a workpiece by a laser beam is provided. The sensor device comprises at least one filter module for filtering a process beam generated during the execution of the laser machining process, and a sensor unit for detecting an intensity of the filtered process beam in at least two measurement channels by at least two photosensors. The filter module is configured to adjust at least one partial wavelength range of the process beam that can be detected in one of the measurement channels of the sensor unit (measurement channel wavelength range of the process beam).

The adjustment may be carried out by limiting the at least one partial wavelength range on one or both sides, in particular by filtering the wavelengths outside the desired partial wavelength range.

In embodiments, other measurement channel wavelength ranges or wavelength ranges of other measurement channels are not adjusted by the filter module, i.e., they pass through the filter module substantially unchanged.

According to a further aspect of the present disclosure, a laser machining system is specified. The laser machining system comprises a laser machining head configured to radiate a laser beam onto a workpiece in order to perform a laser machining process and a sensor device according to aspects and embodiments of the present disclosure.

The aspects of the present disclosure may have one or more of the following optional features.

The sensor unit may comprise at least two photosensors.

The filter module may be arranged, in particular coaxially, in the beam path of the process beam. The filter module may be arranged in the beam path of the process beam in front of the sensor unit. The sensor unit may be arranged in the beam path of the process beam. The sensor unit may be arranged in the beam path of the process beam filtered by the filter module.

The filter module and the sensor unit may be arranged coaxially with respect to each other. The filter module may be arranged coaxially in the beam path of the process beam in front of the sensor unit. The filter module may be arranged in the beam path of the process beam, in particular in front of the first beam splitter and/or in front of a focusing optics of the sensor unit. The filter module and the sensor unit may be arranged on one axis.

In particular, an optical axis of the filter module and an optical axis of the sensor unit may be coaxial with each other and/or each coaxial with an optical axis of the sensor device and/or a beam axis of the process beam having entered the sensor device.

The optical axis of the filter module may be defined as a central axis of the filter module. The sensor unit may comprise a focusing optics through which the process beam enters the sensor unit. In this case, the optical axis of the sensor unit may be defined by the focusing optics of the sensor unit. The sensor device may have an optical input, and the optical axis of the sensor device may also be defined as a central axis of the optical input. In addition, the sensor device may comprise a focusing optics, for example a focusing lens, for focusing the process beam that has entered the sensor device. In this case, the focusing optics may define an optical axis of the sensor device.

The filter module and/or elements included therein, in particular optical elements, for example optics, lenses, or optical filters, may be provided in the sensor device so as to be insertable and/or exchangeable. The filter module may be provided in an insertable manner between the sensor unit and a housing of a laser machining head.

The filter module may be configured as a filter cartridge and/or as a filter insert. A filter cartridge may in particular refer to a filter module enclosed by protective glass. This simplifies the modular configuration of the sensor device. The filter insert may be insertable into a housing of the sensor device. The filter insert or filter cartridge may comprise one or more individual filters.

The sensor device may further comprise the housing. The housing may define an exterior of the sensor device. The housing or sensor device may have an optical input for introducing the process beam into the housing or sensor device. The at least one filter module and/or the sensor unit may be arranged within the housing or may be insertable therein.

Alternatively or additionally, the filter module and the sensor unit may each comprise their own housing and/or may be provided as independent and/or self-contained components.

The sensor device may include a coupling device for coupling the sensor device to a laser machining head. The coupling device may be arranged on the housing and/or attached to the housing. The coupling device may include the optical input.

The at least one adjusted measurement channel wavelength range of the process beam may be 250 nm or less, in particular 100 nm or less, in particular 50 nm or less, in particular 25 nm or less, in particular 10 nm or less. In other words, the adjusted partial wavelength range may have a spectral width of 250 nm or less, in particular 100 nm or less, in particular 50 nm or less, in particular 25 nm or less, in particular 10 nm or less.

The adjusted measurement channel wavelength range may comprise visible wavelengths or (near) infrared wavelengths. The adjusted measurement channel wavelength range may include at least one wavelength selected from: 400 nm, 500 nm, 600 nm, 700 nm, 750 nm, 800 nm, a wavelength equal to or greater than 1200 nm, equal to or greater than 1300 nm, a wavelength of an emission line of aluminum oxide, a wavelength of an emission line of iron oxide, an atomic emission line of a machining material or an alloy component of a machining material, and a wavelength of an atomic emission line, in particular of copper, aluminum, or iron. In particular, a mean or central wavelength of the adjusted measurement channel wavelength range may correspond to one of the listed wavelengths.

The sensor device may comprise at least one beam splitter. The at least one beam splitter, i.e., one beam splitter or a plurality of beam splitters, may form a beam splitter arrangement. The beam splitter may be configured to couple out a partial beam from the filtered process beam. The partial beam may comprise a wavelength or a wavelength range in the at least one adjusted measurement channel wavelength range. Alternatively or additionally, the at least one partial beam may comprise a wavelength or wavelength range corresponding to another measurement channel, i.e., a measurement channel that does not comprise said partial wavelength range of the process beam, and/or a wavelength or wavelength range in an unadjusted measurement channel wavelength range of the process beam.

For example, a first coupled-out partial beam may comprise a wavelength range in the adjusted measurement channel wavelength range and/or a second coupled-out partial beam may comprise a wavelength range in an unadjusted measurement channel wavelength range.

A first photosensor of the sensor unit may be configured to detect the intensity of the first partial beam. A second photosensor of the sensor unit may be configured to detect the intensity of the second partial beam.

For example, a coupled-out partial beam may comprise a first wavelength range in the adjusted measurement channel wavelength range and a second wavelength range different from the first wavelength range. The sensor unit may comprise a so-called two-color sandwich photodiode as one of the photosensors. A first photodiode of the sandwich photodiode may be configured to detect an intensity of the partial beam in the first wavelength range and may be transparent to wavelengths in the second wavelength range. A second photodiode of the sandwich photodiode may be arranged after the first photodiode in the beam propagation direction and/or may be configured to detect an intensity of the partial beam in the second wavelength range.

The at least one beam splitter may have a coating specific to wavelength range.

The plurality of photosensors may be configured to detect an intensity of a corresponding one of the at least one partial beam. Each of the photosensors may be configured to generate a corresponding sensor signal based on the respectively detected intensity. A sensor signal, in particular the strength of the sensor signal, may represent the intensity of the respectively detected wavelength range. The sensor signals may be analog signals or may be digital signals. The sensor signals may be voltage signals.

Each of the photosensors may comprise at least one of the following elements or be one of the following elements: a photosensitive chip, a photosensitive element, a photodiode, a photodiode array, a camera, a pixel array, a CMOS chip, a CCD chip, a spectrometer, a sandwich photodiode, and an optical sensor.

A width of the spectral sensitivity range (also referred to as spectral sensitivity) of the photosensors, in particular the first photosensor, may be 500 nm or more, in particular 750 nm or more.

The filter module may comprise at least one filter. The filter module may comprise one or more filters. The at least one filter may be configured as a notch filter or as a long-pass filter or as a short-pass filter or as a multi-bandpass filter or as a multi-notch filter. The sensor device may comprise a plurality of filter modules.

A transmission wavelength range of the filter module or filter may define a wavelength range transmitted through the filter module or filter. The filter module or filter may have a blocking wavelength range. The blocking wavelength range may define a wavelength range not transmitted or blocked by the filter module or filter. A blocking wavelength range may be spectrally arranged between two transmission wavelength ranges. That is, the two transmission wavelength ranges may be spectrally spaced apart from each other around the blocking wavelength range. In this way, the filter module may be configured in a manner specific to processes in order to adjust to a broadband measurement channel wavelength range of the process beam. The respective transmission wavelength ranges of the filter module may be defined such that they do not overlap.

At least one of the transmission wavelength ranges of the filter module may be a wavelength range that is open on one side (i.e., half-open). This transmission wavelength range may be 100 nm or more, in particular 500 nm or more, wide. In other words, this transmission wavelength range may have a spectral width of 100 nm or more, in particular 500 nm or more.

The filter module may include a multi-bandpass filter. Alternatively or additionally, the filter module may include a long-pass filter and a notch filter. The filter module may have a first transmission wavelength range and a second transmission wavelength range. The first transmission wavelength range may be narrowband. The second transmission wavelength range may be broadband. The first transmission wavelength range may be or include a wavelength range in the visible wavelength range. The first transmission wavelength range may include the visible wavelength range. The second transmission wavelength range may include wavelength ranges in the back-reflection wavelength range and in the infrared wavelength range. The second transmission wavelength range may include the back-reflection wavelength range and the infrared wavelength range. The first transmission wavelength range and the second transmission wavelength range may be spaced apart by a blocking wavelength range.

The laser machining system comprises a laser machining head configured to radiate a laser beam onto a workpiece to perform a laser machining process, and a sensor device according to one of the preceding embodiments. The laser machining head may comprise at least one beam splitter for coupling out the process beam from the beam path of the laser beam and/or for coupling the process beam into the sensor device. The beam splitter of the laser machining head may be arranged inside the housing of the laser machining head. The beam splitter may be arranged in the beam path of the laser beam and in the beam path of the process beam generated during the laser machining process and having entered the laser machining head. The beam splitter may be configured to couple out the process beam from the beam path of the laser beam to the sensor device.

The laser machining system may further comprise a control unit. The control unit may be configured to receive and/or set a gain and/or evaluate the sensor signals. In particular, the control unit may be configured to evaluate the sensor signals separately. The control unit may also be configured to control the laser machining process and/or to regulate and/or monitor the laser machining process based on the sensor signals. In particular, the control unit may be configured to detect, based on the sensor signals, whether there is a process error in the laser machining process.

The control unit may be configured to evaluate and/or record the sensor signals. In particular, the sensor signals may be evaluated separately for each of the sensor signals. Consequently, each wavelength range and/or each measurement channel may be evaluated and monitored separately. The control unit may be configured to convert the (analog) sensor signals to digital signals.

The laser machining system, in particular the control unit, may be configured to set an individual gain for each sensor signal.

The laser machining process may comprise or be laser welding, laser cutting, laser soldering, or laser cladding on a workpiece. The workpiece may be a metallic workpiece.

According to a further aspect of the present disclosure, a sensor device for monitoring a laser machining process for machining a workpiece by a laser beam is provided. The sensor device comprises at least one filter module configured to filter the process beam generated during the execution of the laser machining process, wherein the at least one filter module has at least one narrowband transmission wavelength range and at least one broadband transmission wavelength range and/or at least one further narrowband transmission wavelength range, and a sensor unit for detecting an intensity of the filtered process beam, comprising at least one beam splitter configured to split the filtered process beam into at least two partial beams and at least two photosensors, each of the photosensors being configured to detect the intensity of a corresponding partial beam of the at least two partial beams.

According to a further aspect of the present disclosure, a sensor device for monitoring a laser machining process for machining a workpiece by a laser beam is provided. The sensor device comprises a filter module or a plurality of filter modules for filtering a process beam generated during the execution of the laser machining process, wherein the filter module has at least one narrowband transmission wavelength range and at least one broadband transmission wavelength range, and a sensor unit for detecting an intensity of the filtered process beam, wherein the sensor unit comprises at least one beam splitter for coupling out a first partial beam with the narrowband transmission wavelength range from the filtered process beam and a first photosensor for detecting an intensity of the first partial beam.

### BRIEF DESCRIPTION OF THE FIGURES

Embodiments of the present disclosure are described below with reference to the figures. In the figures:

FIG. 1 shows a laser machining system according to embodiments of the present disclosure;

FIG. 2A shows a schematic view of a sensor device according to embodiments of the present disclosure;

FIG. 2B shows another schematic view of a sensor device according to embodiments of the present disclosure;

FIG. 3A shows a schematic view of a sensor device according to embodiments of the present disclosure;

FIG. 3B shows another schematic view of a sensor device according to embodiments of the present disclosure;

FIG. 4A shows a schematic view of a sensor device according to embodiments of the present disclosure;

FIG. 4B shows another schematic view of a sensor device according to embodiments of the present disclosure;

FIG. 5A shows a schematic view of a filter module according to embodiments of the present disclosure;

FIG. 5B shows another schematic view of a filter module according to embodiments of the present disclosure;

FIG. 6A shows a diagram illustrating a transmission spectrum of a filter module and adjusted measurement channel wavelength ranges according to embodiments of the present disclosure;

FIG. 6B shows another diagram illustrating a transmission spectrum of a filter module and adjusted measurement channel wavelength ranges according to embodiments of the present disclosure;

FIG. 6C shows another diagram illustrating a transmission spectrum of a filter module and adjusted measurement channel wavelength ranges according to embodiments of the present disclosure;

FIG. 7A shows a diagram illustrating a transmission spectrum of a filter module and adjusted measurement channel wavelength ranges according to embodiments of the present disclosure;

FIG. 7B shows another diagram illustrating a transmission spectrum of a filter module and adjusted measurement channel wavelength ranges according to embodiments of the present disclosure;

FIG. 8A shows a diagram diagrams illustrating a transmission spectrum of a filter module and adjusted measurement channel wavelength ranges according to embodiments of the present disclosure;

FIG. 8B shows another diagram illustrating a transmission spectrum of a filter module and adjusted measurement channel wavelength ranges according to embodiments of the present disclosure; and

FIG. 9 shows a diagram illustrating a sensor signal for the intensity of the process beam during laser welding in a broadband wavelength range.

### DETAILED DESCRIPTION

Corresponding elements and dimensions are designated with the same reference signs throughout the figures.

Unless otherwise noted, the same reference signs are used for identical and equivalent elements hereinafter. Redundant descriptions of recurring features are avoided. The various embodiments and features of the figures described below are expressly combinable and should not be understood as self-contained configurations.

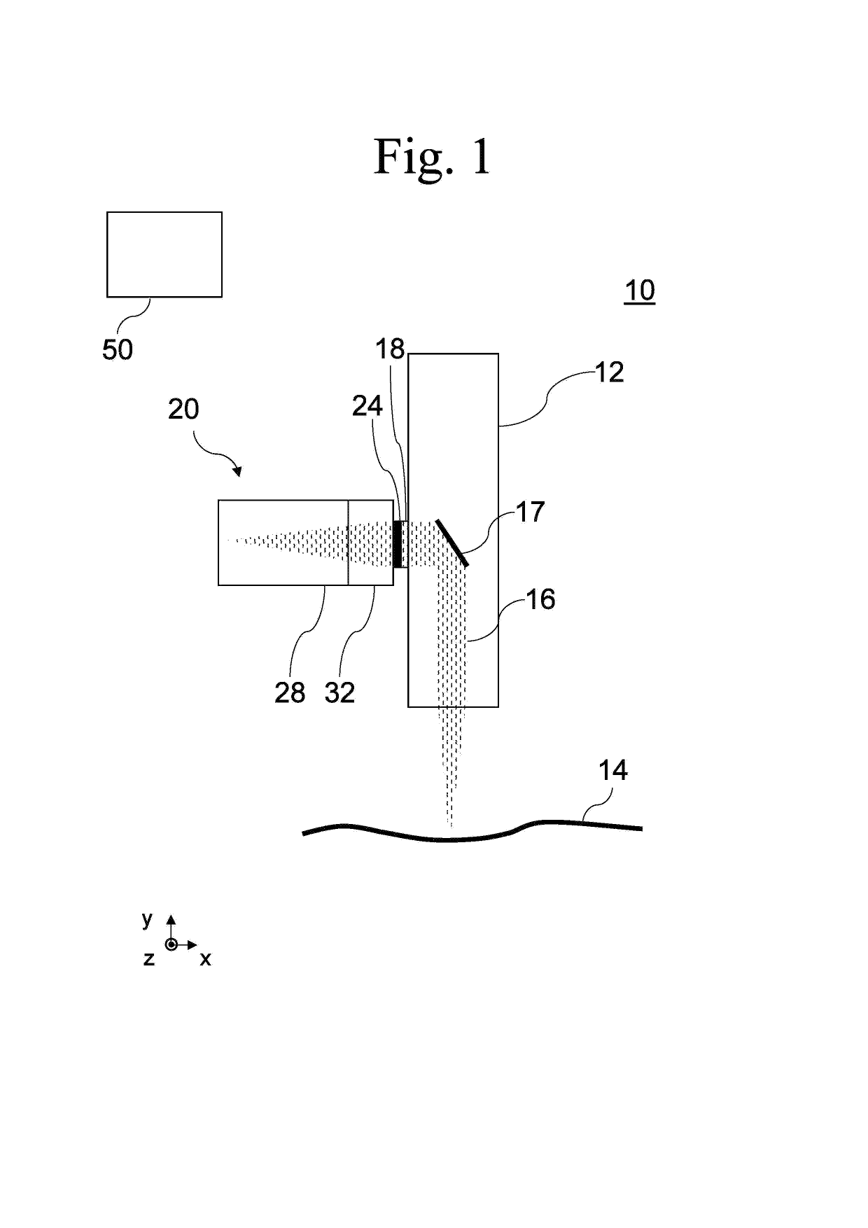

FIG. 1 shows a laser machining system 10 according to embodiments of the present disclosure.

The laser machining system 10 is configured to perform a laser machining process and comprises a laser machining head 12. In order to perform a laser machining process, a laser beam (not shown) is radiated onto a workpiece 14 by the laser machining head 12, which may comprise collimating, focusing, and/or beam shaping optics, thereby heating, melting, and, if necessary, vaporizing the material of the workpiece 14. The workpiece 14 may be a metallic workpiece and may comprise, in particular, iron, stainless steel, or aluminum. The laser machining process may comprise laser welding, laser cutting, laser soldering, or laser cladding.

During the laser machining process, a process beam 16 is created, which enters the laser machining head 12 and is coupled out from a beam path of the laser beam (not shown) by a beam splitter 17. The process beam 16 comprises the laser radiation scattered or reflected back from the workpiece 14, radiation in the infrared wavelength range of light, e.g., temperature radiation from a melt pool, and radiation in the visible wavelength range of light, e.g., radiation from a plasma generated by the machining. The process beam 16 usually has a continuous wavelength spectrum.

In order to couple out the process beam 16, the laser machining head 12 may include a first coupling device 18 and an optical output (not shown). The optical output may be combined with the first coupling device 18. The process beam 16 is coupled out via the optical output of the laser machining head 12.

The laser machining system 10 further comprises a sensor device 20 for monitoring the laser machining process according to embodiments of the present disclosure. The sensor device 20 may also be referred to as a detector. Monitoring is performed by detecting an intensity of the process beam 16 generated during the laser machining process. The sensor device 20 includes an optical input (not shown) for introducing or coupling the process beam 16 into the sensor device 20. The sensor device 20 may further comprise a second coupling device 24 for coupling the sensor device 20 to the laser machining head 12. The coupling device 24 may be combined with the optical input and/or the coupling device 24 may comprise the optical input.

The beam splitter 17 for coupling out the process beam 16 may be arranged in the laser machining head 12 after a focusing optics (not shown) of the laser machining head 12 in the beam path of the process beam 16. The process beam 16 may thus be coupled into the sensor device 20 in a collimated manner. In addition, the sensor device 20 and/or the sensor unit 28 may comprise a focusing optics, for example a focusing lens, for focusing the process beam 16 coupled into the sensor device 20. The beam axis 27 of the process beam 16 may coincide with an optical axis of the focusing optics. The focusing optics may be provided for focusing the process beam 16 or partial beams described later onto photosensors also described later.

The laser machining system 10 shown in FIG. 1 may further comprise a control unit 50 receiving the sensor signals from all photosensors. The control unit 50 may be configured to control the laser machining process based on the received sensor signals. In particular, the control unit 50 may be configured to detect, based on the received sensor signals, whether a process error of the laser machining process has occurred. The control unit 50 may also be configured to set an individual gain for each sensor signal.

The control unit 50 may further be configured to evaluate and/or record the sensor signals. In particular, the sensor signals may be evaluated separately for each of the sensor signals or separately from the other sensor signals. Consequently, each wavelength range may be evaluated and monitored separately.

The sensor device 20 is described in detail below.

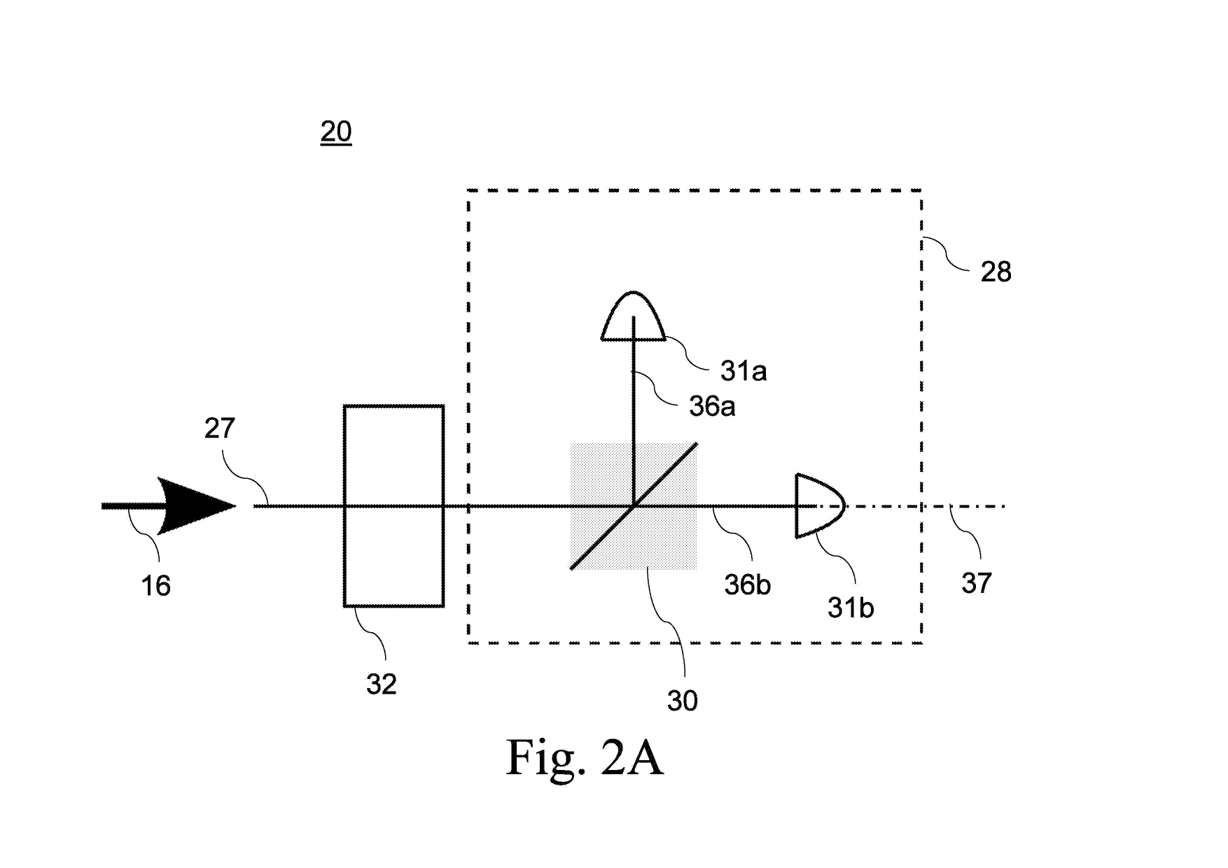

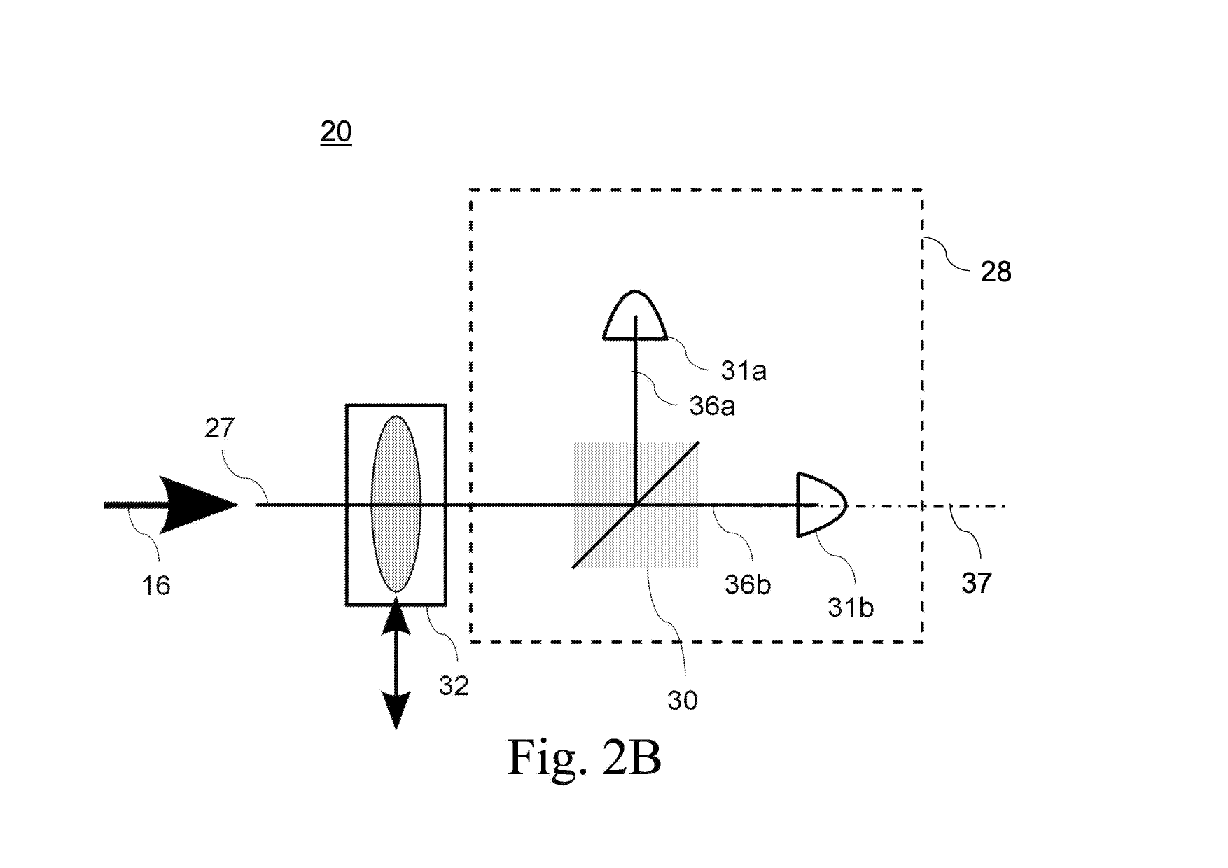

FIGS. 2A and 2B show schematic views of a sensor device for monitoring a laser machining process for machining a workpiece using a laser beam according to embodiments of the present disclosure.

The sensor device 20 comprises a filter module 32 and a sensor unit 28 including at least one beam splitter 30 and at least one first photosensor 31a and one second photosensor 31b, which may be photodiodes, for example. The filter module 32 is arranged so as to filter the process beam 16 that is generated during the execution of the laser machining process and coupled into the sensor device 20.

A beam axis 27 of the process beam 16 or beam axes of partial beams 36a, 36b of the process beam 16 are illustrated by lines extending from the optical input (not shown). The filter module 32 and the sensor unit 28 are arranged in the beam path of the process beam 16 or along the beam axis 27 of the process beam 16. More precisely, the filter module 32 is arranged along the beam path of the process beam 16 in front of the sensor unit 28. The filter module 32 may be arranged in the beam path of the process beam 16 that has entered or been coupled into the sensor device 20 and, if applicable, of the process beam 16 focused by a focusing optics (not shown). The sensor unit 28 is arranged in the beam path of the process beam filtered by the filter module 32.

The filter module 32 is arranged coaxially in front of the sensor unit 28. The filter module 32 and the sensor unit 28 are arranged coaxially with respect to the beam axis 27. In particular, the optical axis of the filter module 32 and the optical axis of the sensor unit 28 are coaxial with each other and each coaxial with the beam axis 27 of the process beam. The optical axis of the filter module 32 may be defined as a center axis of the filter module 32. The optical axis of the sensor unit 28 can be defined as a center axis or central axis of one of the elements of the sensor unit 28. For example, the optical axis of the sensor unit 28 is defined by the center axis 37 of the beam splitter 30. Any beam offset of the process beam 16 potentially caused by the beam splitters can be neglected here. The photosensor 31a is arranged coaxially with the beam axis of the partial beam 36a. The photosensor 31b is arranged coaxially with the beam axis of the partial beam 36b.

The beam splitter 30 of the sensor unit 28 is configured to split the filtered process beam into a first partial beam 36a and a second partial beam 36b (which may also be referred to as coupling out the partial beams from the process beam 16) and to direct them onto the photosensors 31a and 31b. For this purpose, the beam splitter 30 may have a corresponding wavelength-specific coating. The first photosensor 31a is configured to detect the intensity of the first partial beam 36a, while the second photosensor 31b is configured to detect the intensity of the second partial beam 36b.

It is the task of the filter module to adjust, in particular to restrict, the measurement channel wavelength range of the process beam 16 for at least one of the measurement channels for improved process monitoring.

The sensor unit 28 shown in FIGS. 2A and 2B detects two (broadband) measurement channels by the two photosensors 31a, 31b and generates corresponding sensor signals. The sensor device 20 therefore comprises two measurement channels. As shown, the process beam 16 is split by the beam splitter 30 into two partial beams 36a, 36b, each of which comprises wavelengths in one of the two measurement channels. The intensity of each partial beam 36a, 36b is detected by one of the photosensors 31a, 31b.

However, the present disclosure is not limited thereto. For example, the sensor unit 28 may be configured to detect a plurality of measurement channel wavelength ranges by photosensors arranged in the beam path of a partial beam of the process beam 16. This is possible, for example, by "two-color sandwich photodiodes" which have two photosensitive chips arranged one after the other with different spectral sensitivity ranges. This allows for separate detection of a first, for example visible, wavelength range and a second, for example (near) infrared, wavelength range in a partial beam.

Furthermore, the present disclosure is not limited to two measurement channels. A sensor unit may also comprise more than two, in particular three or four, measurement channels.

The sensor unit 28 may comprise at least one focusing optics and/or optical filters (not shown).

The filter module 32 may be configured as a stand-alone component and/or as a filter cartridge, and may in particular be provided in the sensor device 20 in a way that it can be inserted or replaced. This is illustrated in FIG. 2B by a double arrow on the filter module 32.

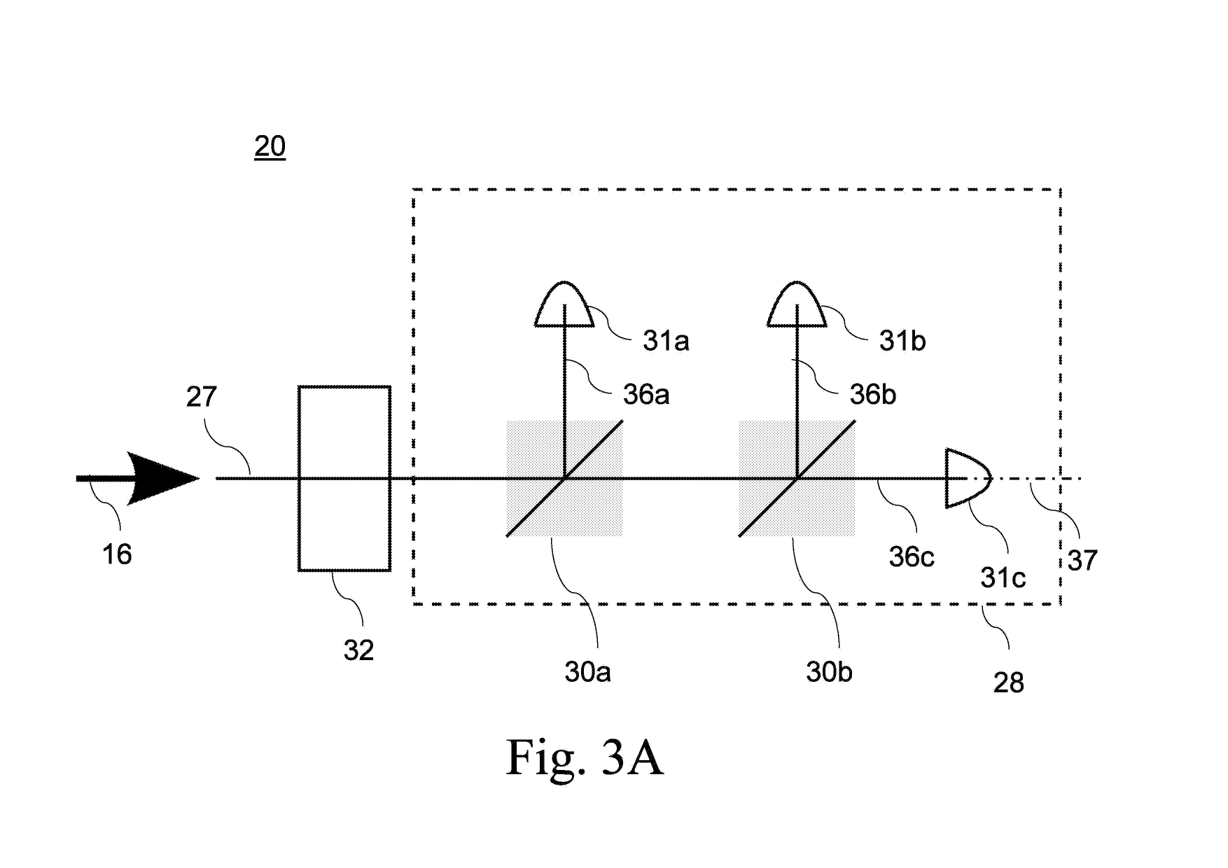

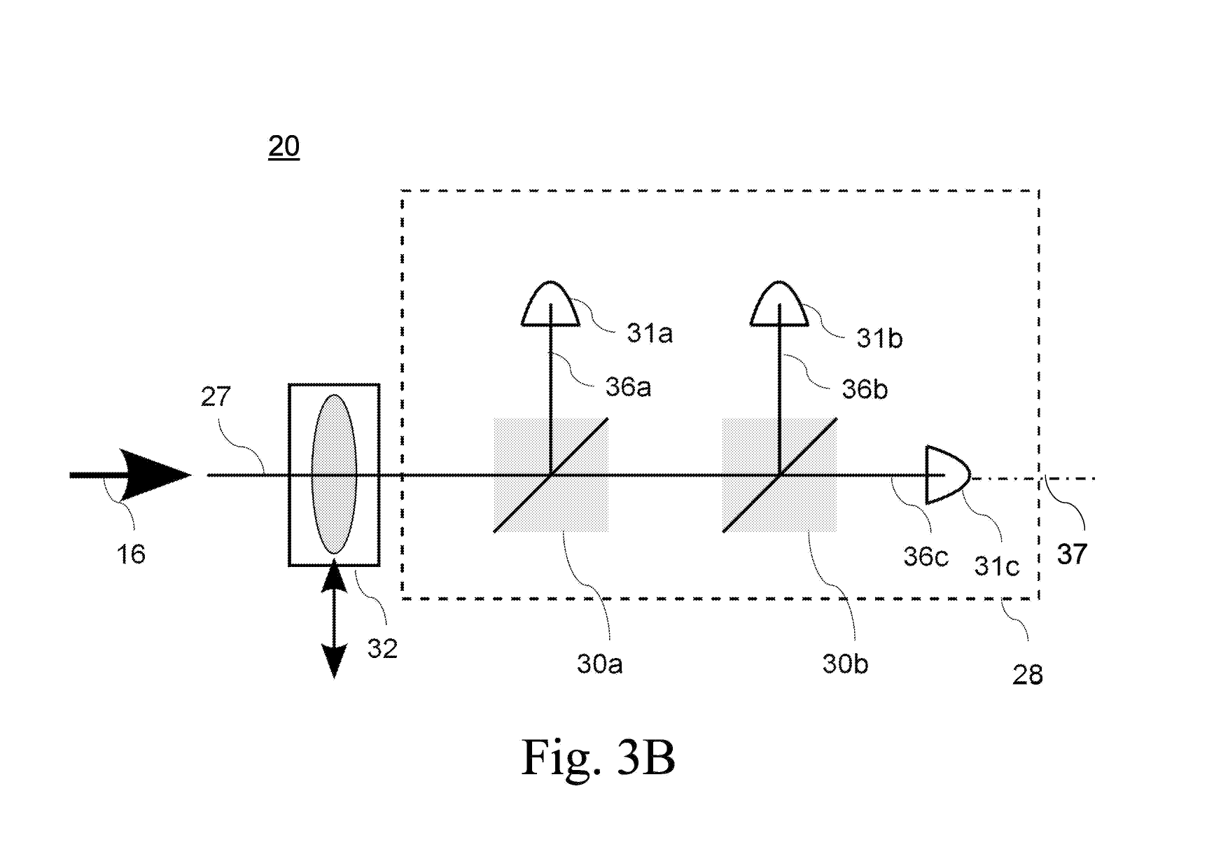

FIGS. 3A and 3B show schematic views of a sensor device for monitoring a laser machining process for machining a workpiece using a laser beam according to further embodiments of the present disclosure.

The embodiments of FIGS. 3A and 3B differ from the embodiments of FIGS. 2A and 2B, respectively, in that there are a plurality of beam splitters 30a, 30b and three photosensors 31a-31c. The embodiment of the sensor device 20 is configured to detect sensor signals for three measurement channels by the three photosensors 31a-31c. The sensor device 20 of FIGS. 3A and 3B therefore comprises three measurement channels.

The beam splitters 30a, 30b of the sensor unit 28 are configured to couple out first to third partial beams 36a-36c from the filtered process beam 16 and to direct them to the corresponding first to third photosensors 31a-36c. For example, the first beam splitter 30a couples out a first partial beam 36a to the first photosensor 31a. The first photosensor 31a is configured to detect the intensity of the first partial beam 36a. The second beam splitter 30b splits the portion of the process beam transmitted by the first beam splitter 30a into the second partial beam 36b and the third partial beam 36c. The second photosensor 31b is configured to detect the intensity of the second partial beam 36b, and the third photosensor 31c is configured to detect the intensity of the third partial beam 36c. The photosensor 31a is arranged coaxially with the beam axis of the partial beam 36a. The photosensor 31b is arranged coaxially with the beam axis of the partial beam 36b. The photosensor 31c is arranged coaxially with the beam axis of the partial beam 36c.

The photosensors 31a, 31b, and, if applicable, 31c are each configured to generate a corresponding sensor signal, for example, an analog voltage signal, based on the respectively detected intensity. For example, the voltage strength may be a measure of the intensity of the respectively detected wavelength range.

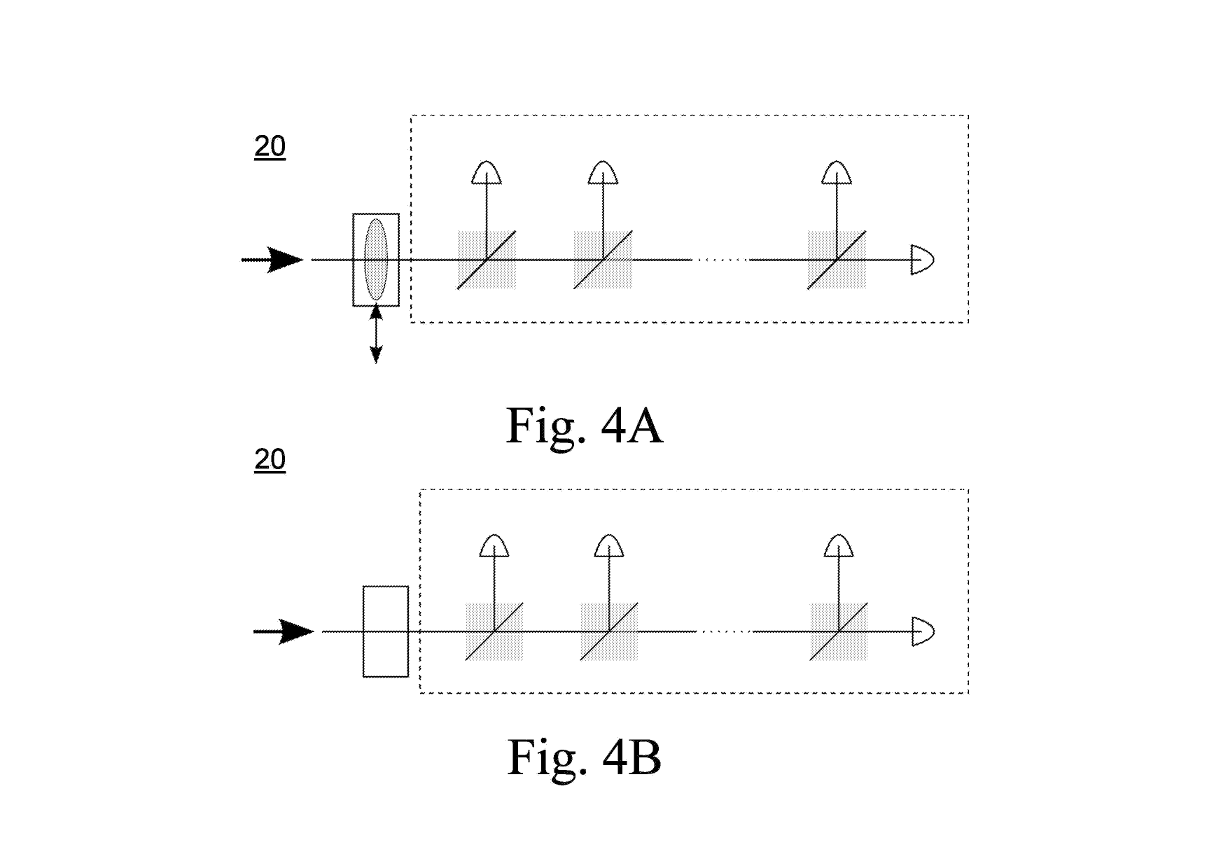

FIGS. 4A and 4B show schematic views of a sensor device for monitoring a laser machining process for machining a workpiece using a laser beam according to further embodiments of the present disclosure.

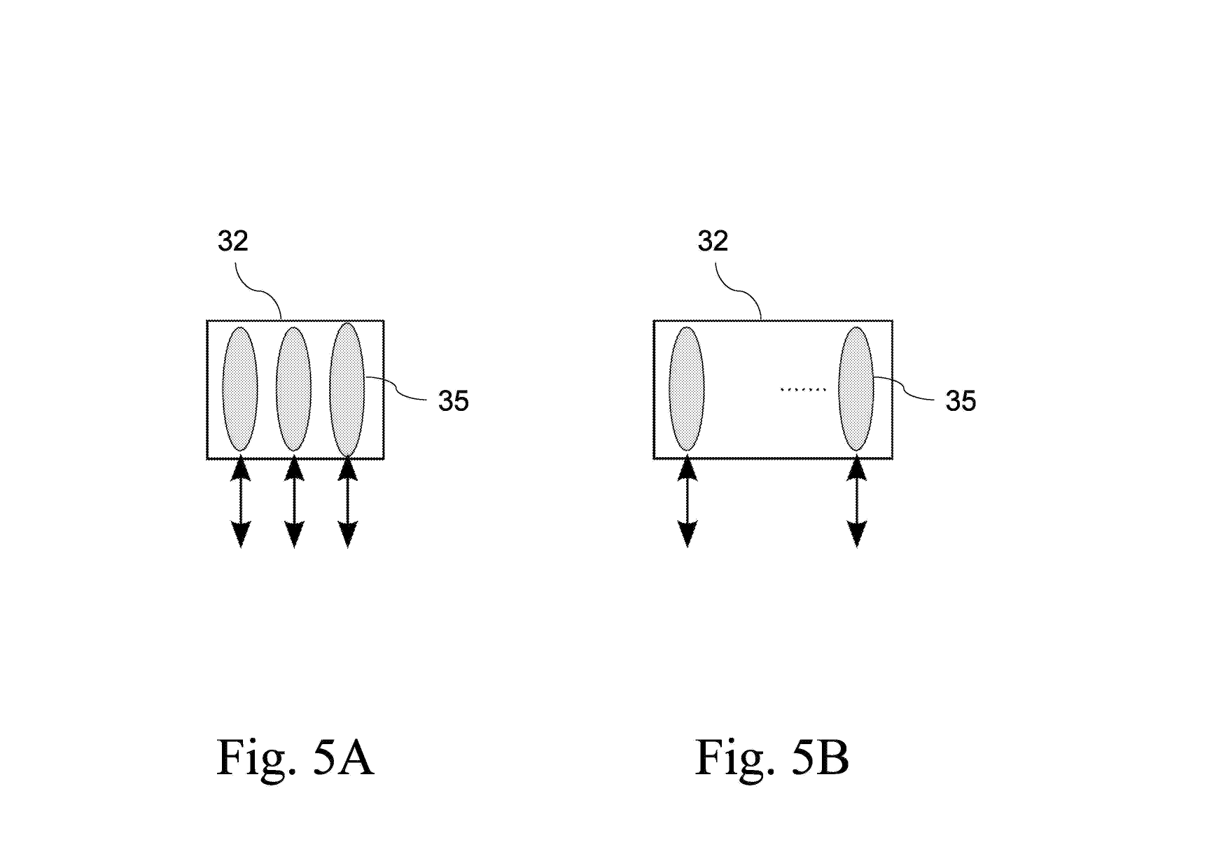

The sensor devices 20 shown in FIGS. 4A and 4B differ from the sensor devices 20 shown in FIGS. 2A and 2B and FIGS. 3A and 3B in that there are three or more beam splitters or four or more photosensors. The sensor unit 28 shown in FIGS. 5A and 5B may therefore comprise four or more measurement channels.

FIGS. 5A and 5B show schematic views of a filter module according to embodiments of the present disclosure. FIG. 5A shows a filter module 32 configured as a filter cartridge. The filter module 32 includes three filters 35. Each of the filters 35 is configured as a filter module that is formed so as to be insertable into the filter cartridge, as illustrated by the double arrows in the figure. FIG. 5B shows a filter module 32 that differs from the filter module shown in FIG. 5A in that it includes more than three filters 35.

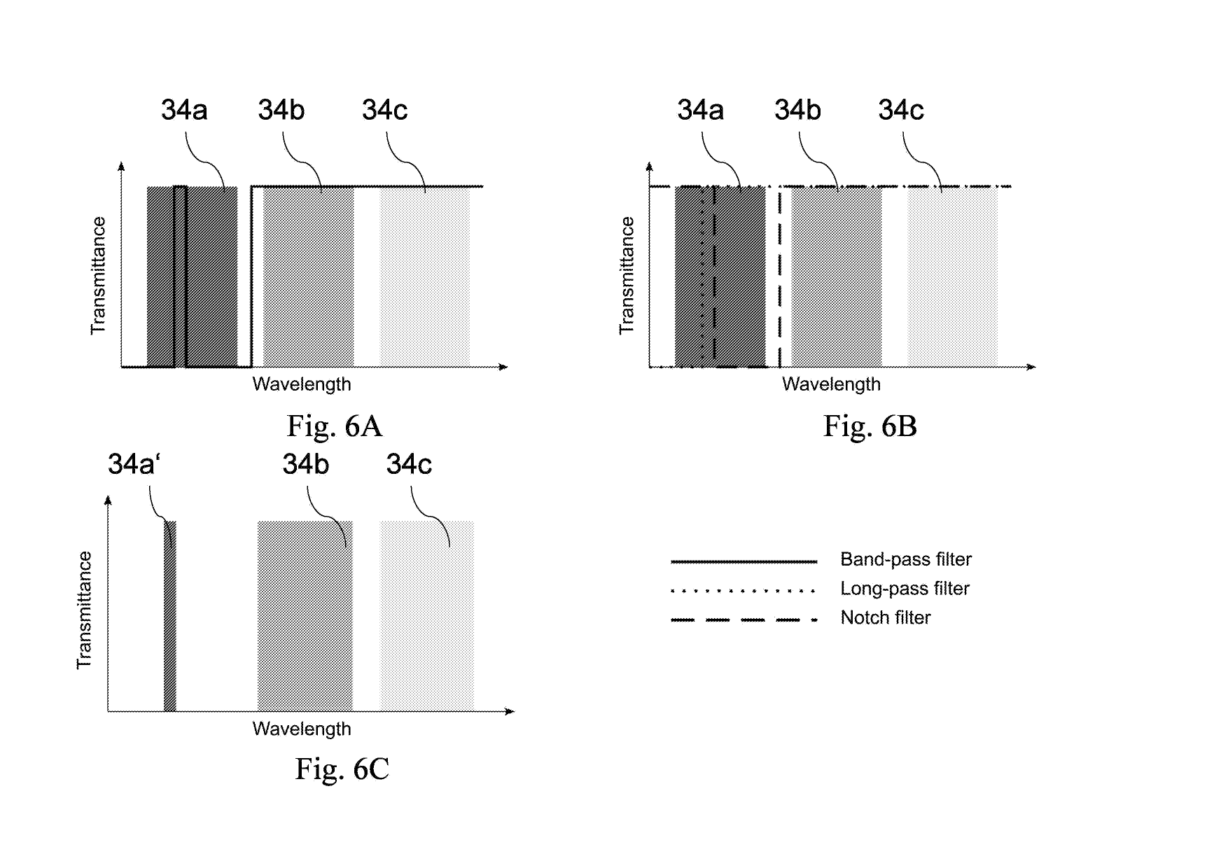

FIGS. 6A-6C show diagrams illustrating a transmission spectrum of a filter module and adjusted measurement channel wavelength ranges according to embodiments of the present disclosure.

The gray areas 34a, 34b, 34c in FIGS. 6A and 6B illustrate partial wavelength ranges of the process beam that can be detected in a measurement channel of the downstream sensor unit (measurement channel wavelength ranges). Accordingly, the sensor unit comprises three measurement channels. The measurement channel wavelength range 34a for the first measurement channel of the sensor unit is to be adjusted in order to obtain the narrower measurement channel wavelength range 34a' shown in FIG. 6C. The measurement channel wavelength range 34a or 34a' may comprise wavelengths or wavelength ranges in the visible wavelength range. The measurement channel wavelength range 34b may comprise wavelengths or wavelength ranges in the back-reflection wavelength range. The measurement channel wavelength range 34c may comprise wavelengths or wavelength ranges in the infrared wavelength range.

As shown in FIG. 6A, a band-pass filter with a narrowband transmission wavelength range in the first measurement channel wavelength range 34a may be provided in the filter module 32 for this purpose. The band-pass filter further comprises a broadband transmission wavelength range comprising the second and third measurement channel wavelength ranges 34b, 34c of the process beam. The band-pass filter may be formed as or comprise a multi-bandpass filter.

The narrowband transmission wavelength range is or comprises a wavelength range in the visible wavelength range. The broadband transmission wavelength range comprises wavelength ranges in the back-reflection wavelength range and in the infrared wavelength range.

As a result, the second and third measurement channel wavelength ranges 34b, 34c are transmitted by the filter module largely unchanged.

Alternatively, as shown in FIG. 6B, a long-pass filter and a notch filter may be provided in the filter module 34. The overlap of the transmission wavelength ranges of these filters results in the same transmission spectrum of the filter module as shown in FIG. 6A.

The filter module discussed in FIGS. 6A and 6B adjusts the measurement channel wavelength range 34a by limiting the measurement channel wavelength range on both sides.

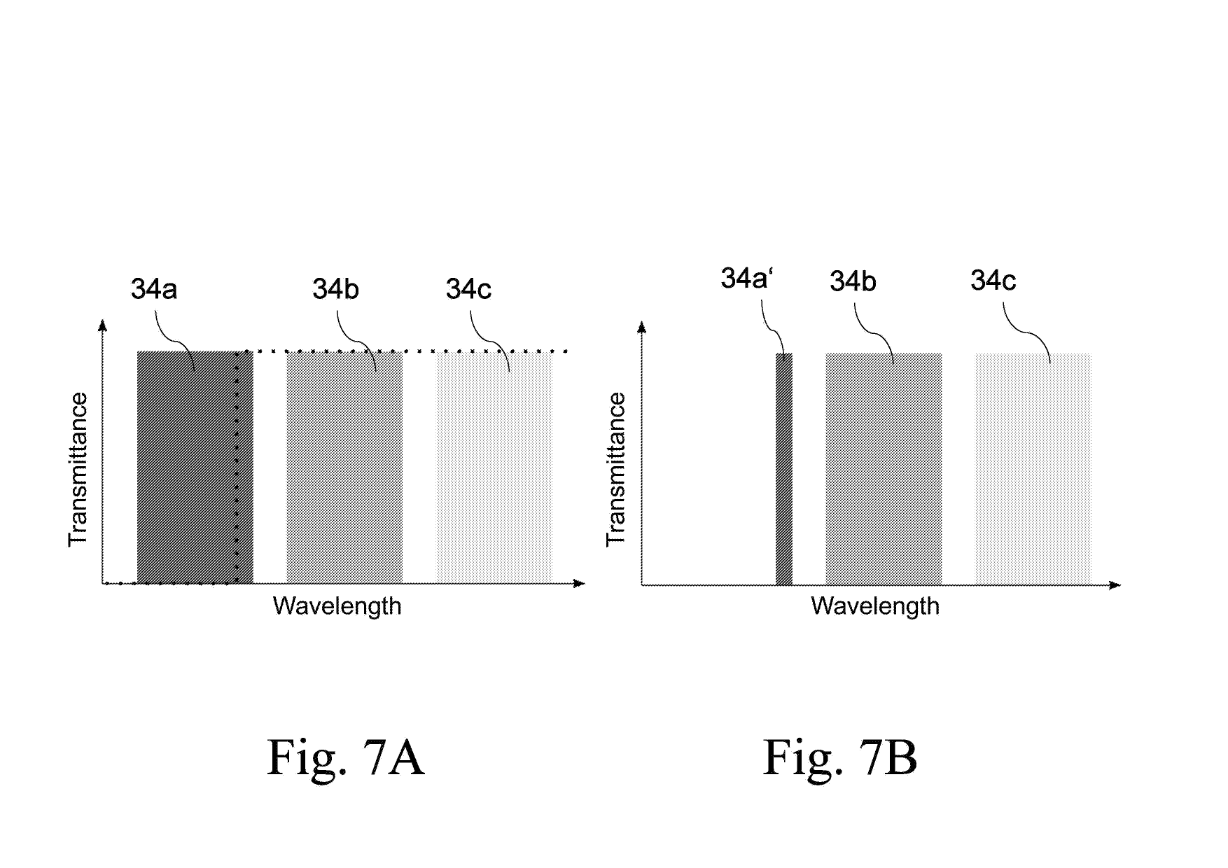

FIGS. 7A and 7B show diagrams illustrating a transmission spectrum of a filter module and adjusted measurement channel wavelength ranges according to embodiments of the present disclosure.

In FIG. 7B, the narrower measurement channel wavelength range 34a' shown is to be obtained starting from the measurement channel wavelength range 34a shown in FIG. 7A.

For this purpose, (only) a long-pass filter is provided in the filter module 34. The long-pass filter is configured such that the measurement channel wavelength range 34a is limited on only one side, namely its lower side. The upper side is predetermined by the measurement channel of the sensor unit, which is determined or limited not only by the spectral sensitivity range of the corresponding photosensor, but also by other optical elements such as beam splitters and optical filters of the sensor unit.

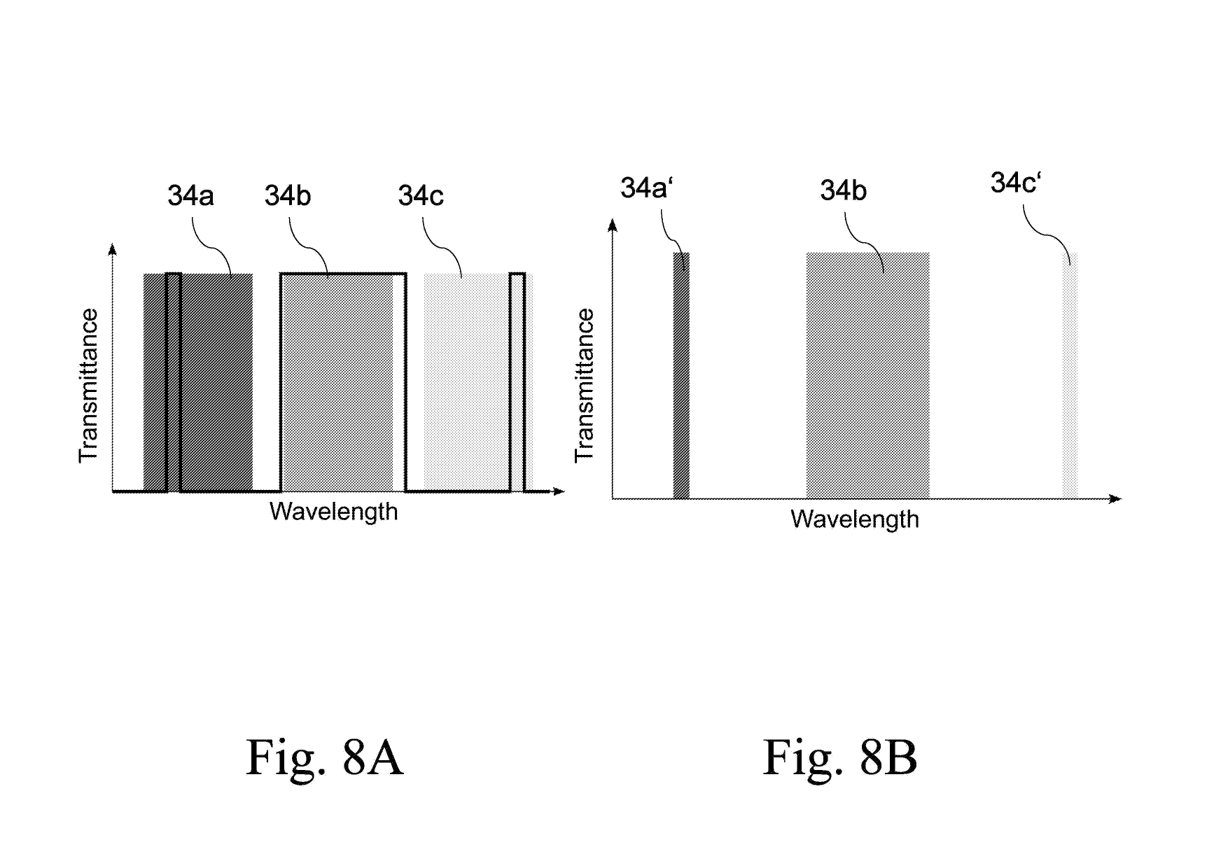

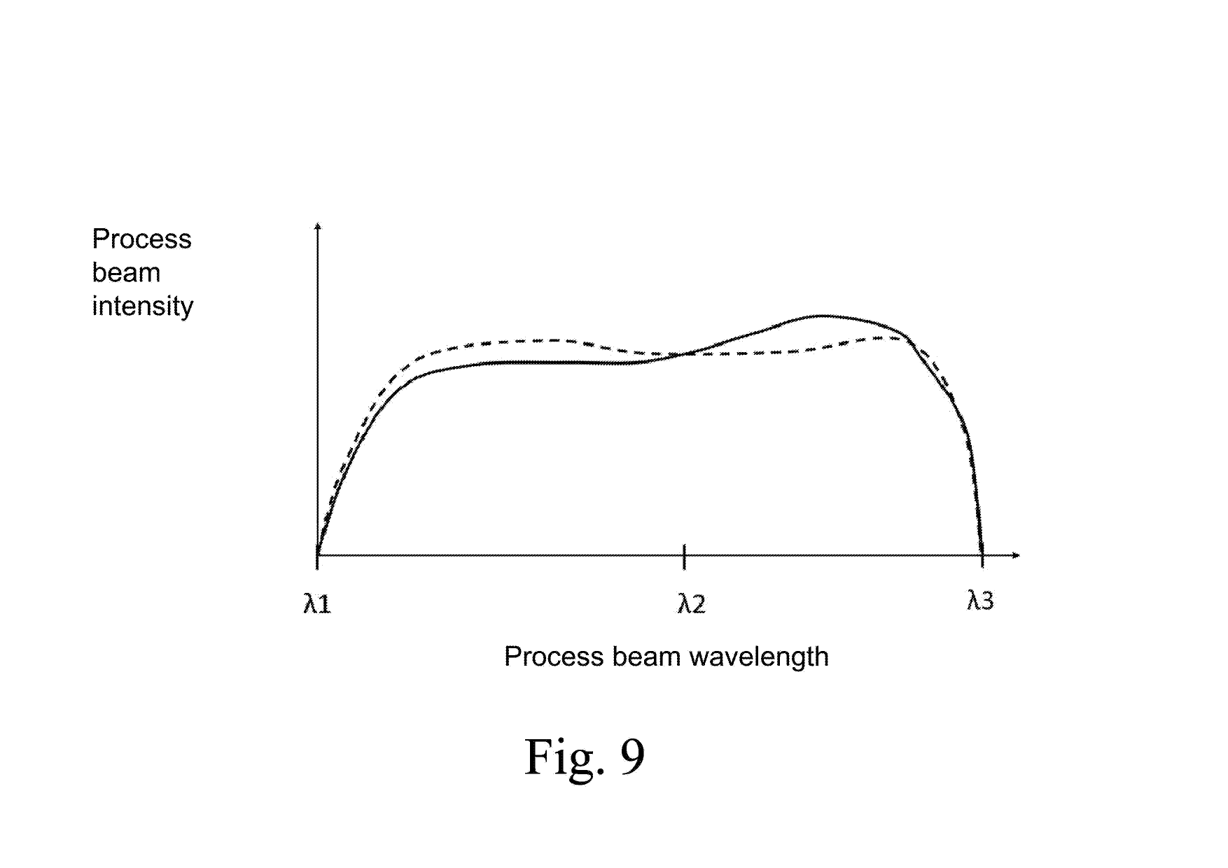

FIGS. 8A and 8B show diagrams illustrating a transmission spectrum of a filter module and adjusted measurement channel wavelength ranges according to embodiments of the present disclosure.

The narrower measurement channel wavelength ranges 34a' and 34c' shown in FIG. 8B are to be obtained starting from the measurement channel wavelength ranges 34a and 34c shown in FIG. 8A.

For this purpose, a multi-bandpass filter is provided in the filter module. Alternatively, a long-pass filter, two notch filters, and a short-pass filter may be provided. The multi-bandpass filter comprises a first narrowband transmission wavelength range in the first measurement channel wavelength range 34a, a second broadband transmission wavelength range comprising the second measurement channel wavelength range 34b, and a third narrowband transmission wavelength range arranged in the third measurement channel wavelength range 34c.

As a result, the second measurement channel wavelength range 34b is transmitted by the filter module largely unchanged.

The present disclosure implements a process-specific spectral evaluation of the process radiation. The implementation is achieved by pre-filtering by at least one filter, which is introduced in a filter module upstream of the sensor unit. According to the present disclosure, a universally applicable, broadband (coaxial) multi-channel sensor device, which allows for great flexibility and universal applicability precisely because of its broadband sensitivity, is combined with a filter module to ensure comprehensive yet precise process monitoring. Thus, the use of a universal broadband (coaxial) multi-channel detector with the flexibility of individual process-specific spectral filtering for improved error detection is made possible. It is also possible to retrofit existing broadband multichannel detectors with a corresponding filter module.

1. A sensor device for monitoring a laser machining process, the sensor device comprising:
at least one filter module for filtering a process beam generated during execution of the laser machining process, and
a sensor unit for detecting an intensity of the filtered process beam in at least two measurement channels by at least two photosensors,
wherein the filter module is configured to adjust at least a partial wavelength range of the process beam, the partial wavelength range being detectable in one of the measurement channels of the sensor unit.

2. The sensor device according to claim 1, wherein the at least one filter module is arranged in a beam path of the process beam in front of the sensor unit and/or wherein the filter module and the sensor unit are arranged on an axis and/or coaxially with respect to each other.

3. The sensor device according to claim 1, wherein the at least one filter module and/or elements included therein are provided in the sensor device in an exchangeable manner, and/or wherein the filter module is configured as a filter cartridge and/or as a filter insert.

4. The sensor device according to claim 1, further comprising a housing with an optical input for introducing the process beam into the housing, wherein the at least one filter module and the sensor unit are arranged within the housing.

5. The sensor device according to claim 1, wherein the at least one adjusted partial wavelength range of the process beam has a spectral width of 250 nm or less, a spectral width of 100 nm or less, a spectral width of 50 nm or less, a spectral width of 25 nm or less, or a spectral width of 10 nm or less.

6. The sensor device according to claim 1, wherein the at least one adjusted partial wavelength range of the process beam includes at least one wavelength selected from: 400 nm, 500 nm, 600 nm, 700 nm, 750 nm, 800 nm, 850 nm, 900 nm, 1200 nm, 1300 nm, a wavelength of an emission line of aluminum oxide, a wavelength of an emission line of iron oxide, and a wavelength of an atomic emission line, in particular of copper, aluminum, or iron.

7. The sensor device according to claim 1, further comprising at least one beam splitter,
wherein the at least one beam splitter is configured to couple out at least one partial beam corresponding to one of the at least two measurement channels of the sensor unit from the filtered process beam.

8. The sensor device according to claim 7, wherein the at least two photosensors are configured to detect an intensity of a corresponding one of the at least one partial beam.

9. The sensor device according to claim 1, wherein each photosensor comprises at least one of the following elements: a photosensitive chip, a photosensitive element, a photodiode array, a camera, a pixel array, a CMOS chip, a CCD chip, a spectrometer, and an optical sensor.

10. The sensor device according to claim 1, wherein the at least one filter module comprises at least one filter selected from: notch filters, long-pass filters, short-pass filters, multi-bandpass filters, and multi-notch filters.

11. The sensor device according to claim 1, wherein the at least one filter module comprises a multi-bandpass filter or the filter module comprises a long-pass filter and a notch filter, and/or
wherein the filter module has a first transmission wavelength range which is or comprises a wavelength range in a visible wavelength range, and wherein the filter module has a second transmission wavelength range which comprises wavelength ranges in a back-reflection wavelength range and in an infrared wavelength range.

12. A laser machining system comprising:
a laser machining head configured to radiate a laser beam onto a workpiece to perform a laser machining process, and
a sensor device according to claim 1.

13. The laser machining system according to claim 12, wherein the laser machining head comprises at least one beam splitter configured to couple out the process beam from a beam path of the laser beam to the sensor device.

14. The laser machining system according to claim 12, wherein each photosensor is configured to generate a sensor signal based on the detected intensity, and
wherein the laser machining system further comprises a control unit configured to evaluate and/or record the sensor signal and/or to monitor and/or control the laser machining process based on the sensor signal.
